(19) United States
(12) Patent Application Publication
(10) Pub. No.: US 2007/0270197 A1
(43) Pub. Date: Nov. 22, 2007

(54) Mobile device with a rotary assembly

(76) Inventor: Chang-Ling Hsieh, Taichung City (TW)

Correspondence Address: CHANG-LING HSIEH, 235 Chung-Ho, Box 8-24, Taipei, omitted

(21) Appl. No.: 11/434,590

(22) Filed: May 16, 2006

(51) Int. Cl. H04M 1/00

(52) U.S. Cl. 455/575.3

(57) ABSTRACT

A mobile device with a rotary assembly comprises a first casing having a pair of pivotal ears; a second casing being movable with respect to the first casing; the second casing having an axial rod penetrating through the second casing; the axial rod being engaged to the two pivotal ears; two protruding ends of the axial rods being protruding from the second casing; one of the two protruding end being installed with a twisting spring; and another one of the two protruding end being installed with a gear set including a driven gear and a driving gear. In assembly, two ends of the twisting spring contact the first casing and second casing. The driving gear is installed to the axial rod; and the driven gear is installed to one of the pivotal ear; the driven gear is driven by the driving gear.

### FIELD OF THE INVENTION

The present invention relates to opening mechanisms of mobile devices, and particular to a mobile device with a rotary assembly, by installing the rotary assembly, a cover of the mobile device can be opened easily with less force. Thereby the lifetime of the mechanism for opening the cover is prolonged.

### BACKGROUND OF THE INVENTION

The mobile devices, such as mobile phones or notebooks are more and more popular with the advantages of convenience.

Other than software, the hardware is also important in the mobile devices. Generally, most of the mobile devices have an openable movable casing and a retaining casing which are combined with a compact size.

As we know, the movable casing of the mobile device has an axial rod which penetrates through an axial hole in the movable casing. The retaining casing has two pivotal ears at two sides of the retaining casing (or the retaining casing has the axial rod and the movable casing has the pivotal ears). The axial rod is installed to the two pivotal ears. Thereby one end of the axial rod is installed with a twisting spring and two ends of the twisting spring are inserted into the retaining casing and the movable casing, respectively. Thus, when the movable casing is opened, the twisting spring will provide a resilient force. Thus, the movable casing can be opened easily with less force. However such design will destroy a block as the mobile device is used for a long time. Furthermore, only the twisting spring is used to drive the movable casing to move upwards, as they are used for a long time, the twisting spring will be fatigue and then it can not be operated successfully.

### SUMMARY OF THE INVENTION

Accordingly, the primary object of the present invention is to provide a mobile device with a rotary assembly, by installing the rotary assembly, a cover of the mobile device can be opened easily with less force. Thereby the lifetime of the mechanism for opening the cover is prolonged.

To achieve above objects, the present invention provides a mobile device with a rotary assembly. The device comprises a first casing having a pair of pivotal ears; a second casing being movable with respect to the first casing; the second casing having an axial rod penetrating through the second casing; the axial rod being engaged to the two pivotal ears; two protruding ends of the axial rods being protruding from the second casing; one of the two protruding end being installed with a twisting spring; and another one of the two protruding end being installed with a gear set including a driven gear and a driving gear. In assembly, two ends of the twisting spring are in contact with the first casing and second casing are driving gear is installed to the axial rod; the driven gear is installed to one of the pivotal ear; the driven gear is driven by the driving gear. The mobile device is a mobile phone. One of the first casing and second casings is installed with a display screen and another one of the first and second casings is installed with a key set. One end of the twisting spring is inserted into one of the first and second casings and another end of the twisting spring is in contact with another one of the first and second casing.

The various objects and advantages of the present invention will be more readily understood from the following detailed description when read in conjunction with the appended drawing.

### BRIEF DESCRIPTION OF THE DRAWINGS

FIG. 1 is an exploded perspective view of the mobile device with a rotary assembly of the present invention.

FIG. 2 is a perspective view of the mobile device with a rotary assembly of the present invention.

FIG. 3 is a schematic view showing the covering operation of the present invention.

FIG. 4 is a schematic view showing the opening operation of the present invention.

FIG. 5 is a schematic view showing that the cover of the mobile device is opened to a predetermined position.

FIG. 6 shows another embodiment of the present invention, where the present invention is used to a computer.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

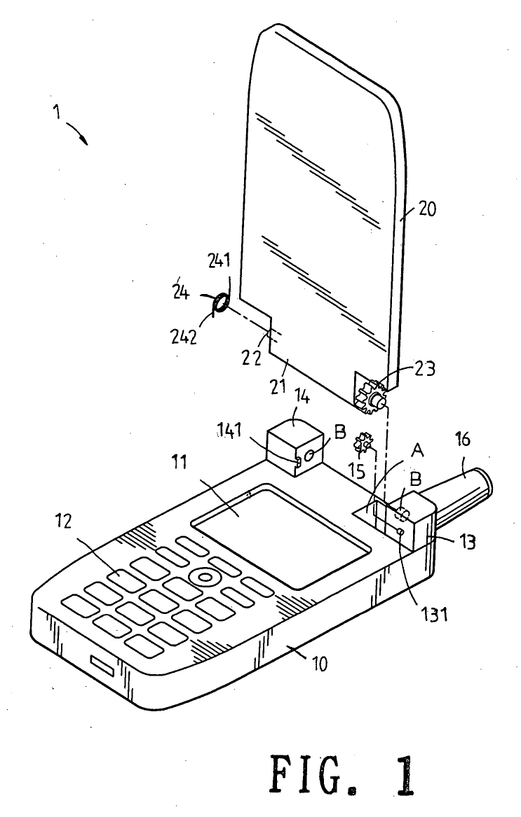

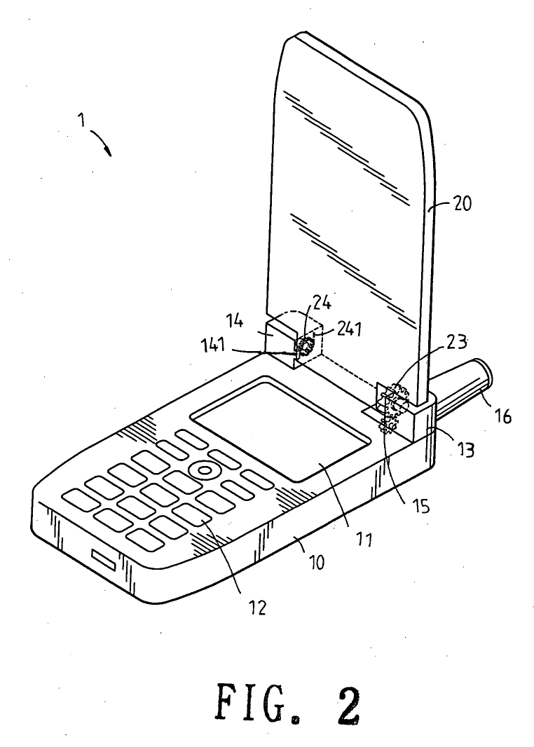

Referring to FIGS. 1 and 2, the structure of the present invention is installed. Those illustrated in the following is only one example of the present invention. However, other structure falling into the scope of the present invention is also contained in the confinement of the present invention. For example, a mobile computer with two openable movable casings is also within the scope of the present invention. The present invention will be described in the following.

A mobile phone product body 1 is included. In the drawing, the body 1 is a mobile phone, an IC circuit assembly of a mobile phone, a flexible circuit board or a battery, etc. However, these are not the main scope of the present invention, and thus the details will not be described herein.

The body 1 of the present invention further has the following elements.

A retaining casing 10 is a surface installed with a display screen 11 and a key set 12. The display screen 11 is one of a light emitting screen, a TFT screen, or an LCD screen. The key set 12 has number keys and function keys. Two sides of the top of the retaining casing 10 are installed with a first pivotal ear 13, and a second pivotal ear 14, respectively. The first pivotal ear 13 and second pivotal ear 14 are symmetrically installed. The first pivotal ear 13 and second pivotal ear 14 are formed as an ear portion. A top surface of the retaining casing 10 is formed with a notch A near the first pivotal ear 13. The first pivotal ear 13 is formed with a pivotal hole 131 which is opened at one lateral side of the notch A.

A driven gear 15 with teeth on a periphery thereof is received in the pivotal hole 131. The size of the notch A is decided according to a diameter of a driven gear 15. A middle section of an inner side of the first pivotal ear 13 is protruded with a block 141 which extends toward the second pivotal ear 14. A center portion of each of the first pivotal ear 13 and second pivotal ear 14 is formed with an axial hole B. A lateral side of the retaining casing 10 near the second pivotal ear 14 is installed with an antenna 16. The antenna 16 may be a hidden antenna which is hidden into the retaining casing 10.

A movable movable casing 20 is included. A lateral side of the movable casing 20 is extended with an axial connection portion 21 which can be installed between the first pivotal ear 13 and the second pivotal ear 14. An axial rod 22 transversally penetrates through the axial connection portion 21. Two ends of the axial connection portion 21 protrude from two lateral sides of the axial connection portion 21 and insert into the axial holes B of the first pivotal ear 13 and the second pivotal ear 14 so that the movable casing 20 can be pivotally retained to the retaining casing 10.

A driving gear 23 has teeth on a periphery thereof. The driving gear 23 is installed around one protruding end of the axial rod 22 and is engaged with the driven gear 15 received in the notch A.

An elastic unit is included. In this embodiment, the elastic unit is a twisting spring 24 with a first leg 241 and a second leg 242. The twisting spring 24 is installed around another protruding end of the axial rod 22. The first leg 241 is inserted into the movable casing 20 and the second leg 242 resists against the block 141 of the second pivotal ear 14. Thus when the movable casing 20 is opened, it provides an elastic positioning effect. Thus, the user uses less force.

The effect of the present invention with the special design of the driven gear 15 and driving gear 23 will be described in the following with the reference of the FIGS. 3 to 5.

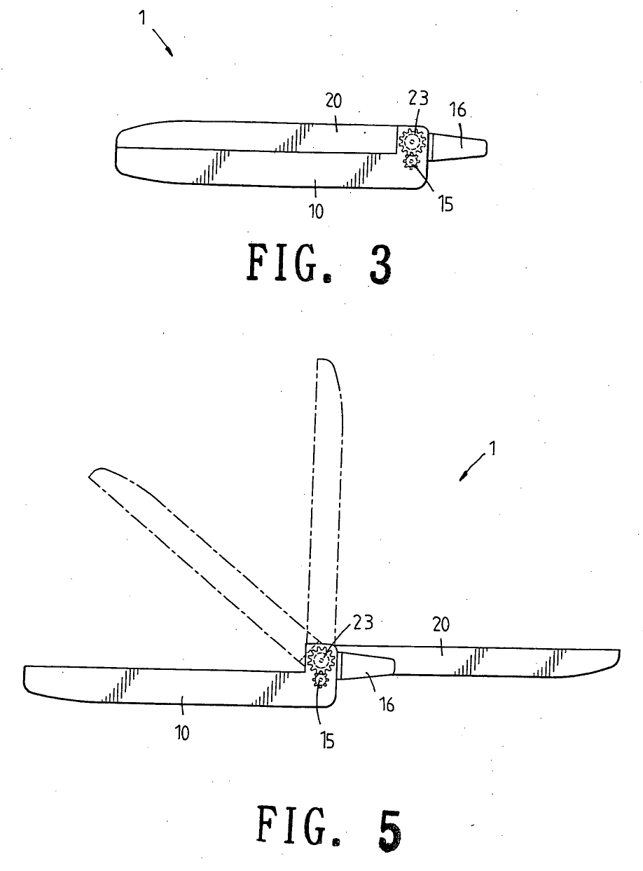

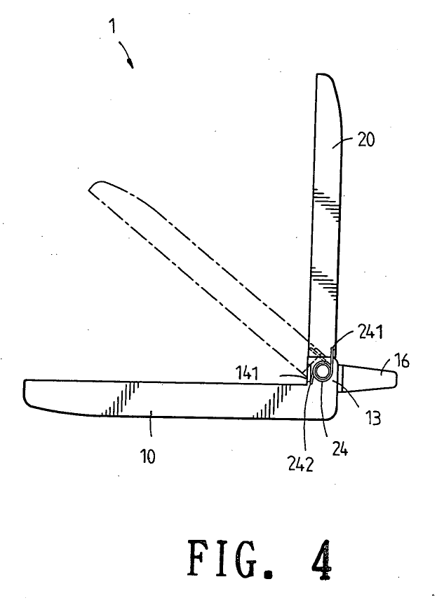

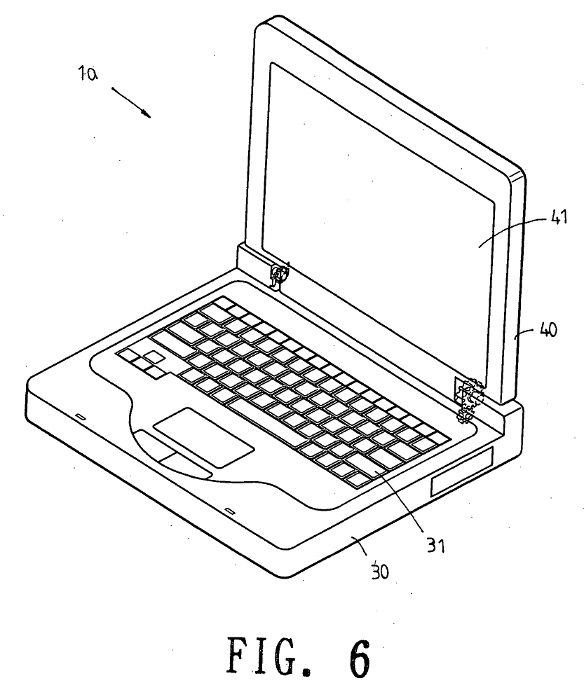

When desiring to listen a call from a mobile phone with a movable casing, as shown in FIG. 3, the movable casing 20 is opened with the assistance of the twisting spring 24. The movable casing 20 is positioned to a predetermined position easily. The driven gear 15 will drive the driving gear 23 to rotate. As a result, the opening operation of the movable casing 20 can be performed easily, conveniently and slowly (referring to FIGS. 4 and 5). Furthermore, the resilient elastic force of the retaining casing 10 can be buffered. Thus, the confinement of the connection and the circuit board near the axial connection portion are protected. Thereby the structure of the mobile phone is prolonged.

Referring to FIG. 6, the present invention can be applied to a notebook computer as illustrated in FIG. 6. The notebook computer la has a retaining casing 30 and a movable casing 40 which are pivotally connected. The retaining casing 30 is installed with a key set 12. The movable casing 20 is installed with a display screen 41. Two ends of the axial rod are installed with a twisting spring and a gear set containing a driving gear and a driven gear.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mobile device with a rotary assembly comprising:
a first casing having a pair of pivotal ears;
a second casing movable with respect to the first casing; the second casing having an axial rod penetrating through the second casing; the axial rod being engaged to the two pivotal ears; two protruding ends of the axial rods being protruding from the second casing; one of the two protruding end being installed with a twisting spring; and another one of the two protruding end being installed with a gear set including a driven gear and a driving gear;
wherein in assembly, two ends of the twisting spring are in contact with the first casing and second casing; and the driving gear is installed to one end of the axial rod; the driven gear is installed to one of the pivotal ear; the driven gear is driven by the driving gear.

2. The mobile device with a rotary assembly as claimed in claim 1, wherein the mobile device is a mobile phone; one of the first casing and the second casings is installed with a display screen and another one of the first and second casings is installed with a key set.

3. The mobile device with a rotary assembly as claimed in claim 1, wherein the mobile device is a notebook computer; one of the first casing and second casings is installed with a display screen and another one of the first and second casings is installed with a key set.

4. The mobile device with a rotary assembly as claimed in claim 1, wherein one end of the twisting spring is inserted into one of the first and second casings and another end of the twisting spring is in contact with another one of the first and second casing.

5. The mobile device with a rotary assembly as claimed in claim 2, wherein one end of the twisting spring is inserted into one of the first and second casings and another end of the twisting spring is in contact with another one of the first and second casing.

6. The mobile device with a rotary assembly as claimed in claim 3, wherein one end of the twisting spring is inserted into one of the first and second casings and another end of the twisting spring is in contact with another one of the first and second casing.

7. The mobile device with a rotary assembly as claimed in claim 1, wherein one of the first and second casing is installed with an antenna.
